(19) United States
(12) Patent Application Publication
(10) Pub. No.: US 2019/0070703 A1
(43) Pub. Date: Mar. 7, 2019

(54) Drill Debris Containment

(71) Applicant: Brandon Neil Robb, Fort Worth, TX (US)

(72) Inventor: Brandon Neil Robb, Fort Worth, TX (US)

(21) Appl. No.: 15/694,907

(22) Filed: Sep. 4, 2017

(51) Int. Cl. B23Q 11/00

(52) U.S. Cl. CPC B23Q 11/0067

(57) ABSTRACT

A system to contain abraded material that is produced by a power-tool during operation on a work piece is presented. The Drill Debris Containment system in an embodiment comprised of compressible, flexible foam and/or durable rubber materials. The Drill Debris Containment system comprised of a large upper opening, smaller lower opening and bottom surface area surrounded by a wall like surface area.

### FIELD OF THE INVENTION

The present invention relates generally to the field of power-tools and more particularly power-tool safety devices.

### BACKGROUND OF THE INVENTION

The invention is based on the prior art design and re-utilization of a common refreshment can insulator. The inventor uniquely re-purposed prior art for the utilization of containment of abraded material caused by a power tools contact with a work-piece.

The common refreshment can insulator comprises ideal features that serve well with the inventions intended utilization.

The drill debris containment as defined in claim 1, wherein the invention is intended for catching abraded material that is produced on a work-piece by a power tool, in particular a power drill. To keep pace with the trend toward weight reduction, cost reduction and simplifying current arts and technologies the Drill Debris Containment can be an ideal.

### SUMMARY OF THE INVENTION

Accordingly, it is an object of the Drill Debris Containment to simplify current versions of the known drill debris capturing devices while maintaining efficiency.

In keeping with these objects and with others which will become apparent hereinafter, one feature of the present invention resides, briefly stated, in a drill debris containment, having the embodiment intended for the use to catch abraded material that is produced by a power tool, in particular a power drill, in operation on a work-piece.

It is proposed that the embodiment be comprised compressible and or flexible foam and or durable rubber materials to create a non-rigid element which allows for the invention to remain flexibly contacted to the work-piece and said drill; Where-in the drill bit may be slightly pushed in and pulled out from the work-piece; Where-in the invention keeps contact with the said drill and work-piece creating housing for abraded material created by the operation of the tool on the work-piece. As a result, it can advantageously be attained that the invention can quarantine the debris from the work-piece and said drill bit inside of the embodiment.

Diffusive devices such as bristles, perforated materials and other diffusive devices may be added and or placed inside the invention embodiment to enhance the containment ability in the process.

Precise work with the power tool can be made possible if the drill debris containment is comprised of a transparent material allowing user to view the work-piece and said drill bit contact point more easily.

Unintended slipping between the invention and the work-piece can be at least extensively avoided if one contact face of the invention is equipped with a nonslip material. As the nonslip liners, bumpy or rubber liners are for instance conceivable.

A spring mechanism may be integrated into the embodiment of the invention for generating a contact pressure on the work-piece, a user can advantageously be supported by the spring mechanism in fixing the invention against the work-piece.

Further advantages will become apparent from the ensuing drawing description. In the drawing, exemplary embodiment's of the invention are shown. The drawing, description and claims include numerous characteristics in combination. One skilled in the art will expediently consider these characteristics individually as well and put them together to make useful further combinations.

### BRIEF DESCRIPTION OF THE DRAWINGS

FIG. 1 shows the Drill Debris Containment, in a lower perspective view;

FIG. 2 shows the Drill Debris Containment, in a side perspective view;

FIG. 3 shows the Drill Debris Containment, in a upper perspective view;

FIG. 4 shows the Drill Debris Containment, in a partially transparent side perspective view;

### DETAILS OF DRAWINGS

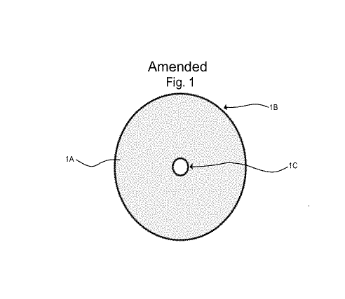

FIG. 1

Shows a Drill Debris Containment, in a lower view. Showing the bottom surface area labeled 1A, which has an opening in the center labeled 1C (In which said drill bit will be entered and passed) The surface area is surrounded by an outside wall label 1B.

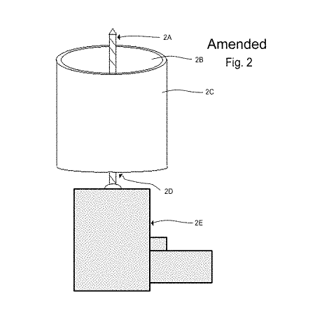

FIG. 2

Shows a Drill Debris Containment, in a side view. Showing the outside wall surface labeled 2C; the embodiment has an upper opening labeled 2B in which the said drill bit labeled 2A will be passed and abraded material from said drill bit and work-piece will enter the contact element for containment. This view also showing the said drill bit entering the lower opening labeled 2D, and the placement of the said drill/power-tool labeled 2E in respect to the Drill Debris Containment.

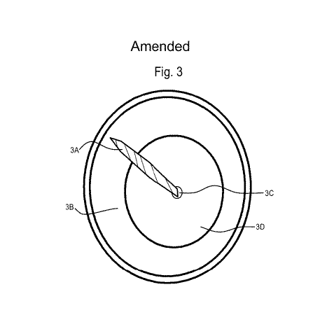

FIG. 3

Shows a Drill Debris Containment, in a upper view. Showing the inner bottom surface area labeled 3D which the provides partial containment for abraded material caused by the said drill bit contacting the work piece. The inner wall surface labeled 3B is adjacent to the inner bottom surface area which provides partial containment for abraded material entering through the larger upper opening. Label 3A shows the said drill bit passing through the upper opening. Label 3C shows the said drill bit entering and passing the lower opening.

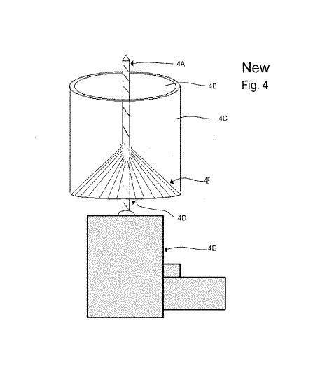

FIG. 4

Shows a Drill Debris Containment, in a partially transparent side view. Showing the outside wall surface labeled 4C being partially transparent to show the added inner embodiment described in claim 10 labeled 4F in the figure; the inner embodiment labeled 4F is shown to be comprised of bristles seated on the surface of the inner walls and inner lower surface of the Drill Debris Containment embodiment. The bristles labeled 4F seated on the inner walls and inner lower surface are extended toward the said drill bit; the embodiment has an upper opening labeled 4B in which the said drill bit labeled 4A will be passed and abraded material from said drill bit and work-piece will enter the contact element for containment. This view also showing the said drill bit entering the lower opening labeled 4D, and the placement of the said drill/power-tool labeled 4E in respect to the Drill Debris Containment.

It will be understood that each of the elements described above, or two or more together, may also find a useful application in other types of constructions differing from the types described above.

While the invention has been illustrated and described as embodied in a drill debris containment, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Robbs Patent is set forth in the appended claims:

1. A Drill Debris Containment system comprising an embodiment forming a removable housing between the work piece and the power tool, intended to catch abraded material that is produced by a power tool during operation on a work-piece. The invention comprised of compressible, flexible foam and or durable rubber materials.

2. The system of claim 1, further comprising the detachable embodiment rests between the said power tool and the work-piece.

3. The system of claim 1, wherein an upper opening and a lower opening in the embodiment; in which a drill bit of said power tool is passed.

4. The system of claim 1, in which the invention forms a housing that encloses dust and having sufficient area to capture abraded material from several uses of drill and or power tool.

5. The system of claim 1, wherein the invention is comprised of compressible and or flexible foam and or durable rubber materials.

6. The system of claim 1, wherein the invention comprises a large opening intended to create a seal around the work-piece contact area allowing abraded material to be dispersed and captured inside the invention.

7. The system of claim 1, wherein the invention comprises a surface area opposite the larger opening sufficient in size to house debris from the power tool and work-piece.

8. The system of claim 1, wherein the invention comprises a small opening which is snug of said drill bit placed through opposite the larger opening.

9. The system of claim 1, wherein the invention comprises a surface area opposite the larger opening which rests on said power tool creating a seal around the said drill bit and drill capturing debris from the power tool and work-piece.

10. The system of claim 1, further comprising the invention may be comprised with bristles or rubber-like flexible strips set inside the inner walls of the embodiment to enhance capture and deflection of the debris created from the work-piece

11. The system of claim 10, in which the bristles or rubber-like flexible strips set on the surface of the inner walls of the embodiment may be extended out from the inner walls and inner lower surface toward the said drill-bit and mayor may not contact the said drill-bit.

12. The system of claim 10, in which the bristles or rubber-like flexible strips may attach to the inner walls of the invention embodiment.

13. The system of claim 10, in which the bristles or rubber-like flexible strips may be its own removable set and embodiment grouped together to be placed inside of the Drill Debris Containment embodiment.
